(19) United States
(12) Patent Application Publication
(10) Pub. No.: US 2026/0063103 A1
(43) Pub. Date: Mar. 5, 2026

(54) SPAR CAP FOR A WIND TURBINE ROTOR BLADE, SET FOR MANUFACTURING A HALF SHELL OF A WIND TURBINE ROTOR BLADE, ASSEMBLY INCLUDING A SPAR CAP AND A MOLD, AND METHOD OF MANUFACTURING A HALF SHELL OF A WIND TURBINE ROTOR BLADE

(71) Applicants: Nordex Blade Technology Centre ApS, Stenstrup (DK); Nordex Energy SE & Co. KG, Hamburg (DE)

(72) Inventors: Tobias Tesching, Ostseebad Nienhagen (DE); Flemming Sörensen, Svendborg (DK); Mathias Hubald, Rostock (DE); Tobias Raschen, Rostock (DE)

(21) Appl. No.: 19/307,763

(22) Filed: Aug. 22, 2025

(30) Foreign Application Priority Data
Sep. 4, 2024 (EP) 24198375.8

(51) Int. Cl. F03D 1/06; B29D 99/00

(52) U.S. Cl. CPC F03D 1/0681; B29D 99/0025; F03D 1/069; F05B 2240/304

(57) ABSTRACT

A spar cap is for a wind turbine rotor blade. The spar cap includes a stack of fiber material layers, which are stacked in a stacking direction from a bottom face to a top face, and a clipping layer which is arranged on the top face of the stack. The clipping layer protrudes beyond the stack of fiber material layers in a lateral direction which is perpendicular to the stacking direction. A set is for manufacturing a half shell of a wind turbine rotor blade. An assembly includes a spar cap and a mold. A method is for manufacturing a half shell of a wind turbine rotor blade.

### CROSS-REFERENCE TO RELATED APPLICATIONS

This application claims priority of European patent application no. 24198375.8, filed Sep. 4, 2024, the entire content of which is incorporated herein by reference.

### TECHNICAL FIELD

The disclosure concerns a spar cap for a wind turbine rotor blade, a set for manufacturing a half shell of a wind turbine rotor blade, an assembly including a spar cap and a mold, and a method of manufacturing a half shell of a wind turbine rotor blade.

### BACKGROUND

Wind turbines with wind turbine rotor blades are widely known from the state of the art and are used to convert wind energy into electrical energy. Wind turbine rotor blades are usually manufactured in an aerodynamic shell configuration and include several components made of fiber-reinforced laminate, such as an aerodynamic shell. Typically, a wind turbine rotor blade has an elongated configuration, having a root for attaching the blade to the rotor hub. The wind turbine rotor blade extends from the root to a tip. Typically, two half shells are produced, which are placed on top of each other after their respective manufacture and bonded together to produce the wind turbine rotor blade. The half shells themselves may be segmented for manufacturing a so-called split blade or segmented blade.

Typically, the elongated wind turbine rotor blade varies its cross-sectional shape widely over its length. The cylindrical root section changes to a flattened air-foil cross-section, which gets smaller and smaller towards the tip. The wind turbine rotor blade has a leading edge and a trailing edge at opposite sides. Especially the shape of the trailing edge varies significantly over the body length.

It is necessary to provide reinforcement structures at or within the wind turbine rotor blade for providing the respectively needed stiffness in view of the loads acting on the rotor blade. A high stiffness in the edge region is required, also in the region of the trailing edge, which, as mentioned, varies its shape and thickness significantly. For stiffening the trailing edge region, one or more spar caps including many separate fiber layers are arranged and respectively integrated in the half shells of the wind turbine rotor blade. The configuration of these spar carps in view of their required mechanical properties or stiffness is challenging, as the spar cap thickness is constrained by the limited space near the trailing edge. Thus, the integration of the spar caps is difficult.

A precise placement of the spar cap near the trailing edge is crucial regarding the structural integrity, the performance, and the efficiency of the wind turbine rotor blade.

### SUMMARY

It is an object of the disclosure to provide an improved spar cap.

This object is achieved via various embodiments of the disclosure.

According to a first aspect, a spar cap for a wind turbine rotor blade is proposed which includes a stack of fiber material layers and a clipping layer. The fiber material layers are stacked in the stack in a stacking direction from a bottom face to a top face. The clipping layer is arranged on the top face of the stack. The clipping layer protrudes beyond the stack of fiber material layers in a lateral direction which is perpendicular to the stacking direction.

The clipping layer, in particular the protruding part of the clipping layer, is configured to be used to fix the spar cap in a mold, thereby allowing to place the spar cap in the mold with a high precision. Any unintentional movements of the spar cap relative to a layup surface of the mold after the placement of the spar cap in the mold can be prevented by fixing the protruding part of the clipping layer. Accordingly, the inventive spar cap is configured to be placed in the mold with a high precision, thereby allowing to construct a half shell of a wind turbine rotor blade in which the spar cap is placed with a high precision.

The spar cap can be one of the main load-bearing components in the rotor blade, configured to withstand bending moments and shear forces. A precise placement of the spar cap ensures that the loads are distributed correctly along the rotor blade. On the other hand, an incorrect placement of the spar cap can lead to an uneven load distribution, resulting in stress concentrations and potential structural failures such as cracks or delamination.

The spar cap helps to maintain the aerodynamic shape of the rotor blade. A precise placement of the spar cap ensures that the rotor blade retains its configured airfoil profile, which is essential for optimal aerodynamic performance. A precise placement of the spar cap in the rotor blade can maximize the rotor blade's ability to capture wind energy efficiently, enhancing the overall performance of the wind turbine.

A precise placement of the spar cap in the rotor blade can contribute to an overall balance of the rotor blade, reducing vibrations during its operation. This extends the lifespan of the rotor blade and minimizes the noise generated by the rotor blade during its operation.

By arranging the clipping layer on the top face of the stack it can be avoided that the clipping layer creates deformations of the stack, in particular so-called undulations. If the clipping layer was in added in the middle of the stack of on the bottom face of the stack, layers of fiber material would be placed above the clipping layer which protrude sideways beyond the clipping layer. This would create a deformation of the otherwise flat fiber material layers, resulting in undulations of the stack. It is crucial that spar caps are free from undulations as only spar caps free from undulations can transfer forces reliably.

The clipping layer may include one or more layers of bidirectional fiber material. For the clipping layer, all kinds of fiber materials may be used, for example, the clipping layer may include tri-axial fiber material.

The clipping layer may also be a prefabricated part including glass fiber reinforced plastic (GFRP). The clipping layer may be formed as a tab. A tab is typically a flat or slightly curved part used for connecting, reinforcing, or fastening other components. The clipping layer may be incorporated into the resin infusion or may be fixed in another manner to the top face of the stack, for example, by gluing or by laminating.

In an embodiment, the stack of fiber material layers and the clipping layer are infused with resin. The stack of fiber material layers and the clipping layer can be enclosed in a vacuum foil before the resin infusion and the resin infusion can be made under a vacuum atmosphere. The stack of fiber material layers and the clipping layer are fixed together permanently by the resin infusion. As it is common to form a spar cap by resin infusion of a stack of fiber material layers, no additional manufacturing step is required for fixing the clipping layer to the stack of fiber material layers.

As an alternative, a clipping layer formed as a prefabricated part including glass fiber reinforced plastic may be fixed to the top face of the stack by gluing or laminating after the stack is infused with resin.

In an embodiment, the clipping layer forms a fixing element configured to fix the spar cap in a mold. The protruding part of the clipping layer can be configured to be clamped between a clamping device and a clamping surface of the mold.

In an embodiment, a chordwise cross sectional shape of the clipping layer is complementary to a chordwise cross sectional shape of a protrusion forming an edge of the mold. This may allow the clipping layer to smoothly abut the protrusion on the mold, thereby further improving the precision with which the spar cap is positioned in the mold.

In an embodiment, the spar cap is a trailing edge spar cap. A trailing edge spar cap is arranged either directly at the trailing edge of a half shell of the rotor blade or in close proximity to the trailing edge of the half shell. Preferably, the spar cap forms the trailing edge at least in a section (region) between the root end of the half shell and the tip end of the half shell.

A second aspect concerns a set for manufacturing a half shell of a wind turbine rotor blade. The half shell manufactured with this set may include the spar cap described above with respect to the first aspect. The embodiments described above with respect to first aspect analogously apply to the second aspect.

The set includes a mold including a layup surface and a protrusion which defines an edge of the mold. The set further includes at least one block which is configured to be arranged on the protrusion to elevate a height of a part of the protrusion.

The half shell manufactured with this set may differ in its dimensions along the longitudinal direction. The block can be used to adapt a height of the protrusion to a shape of the half shell. For example, a trailing edge spar cap of the half shell may have a greater height than the protrusion when the spar cap is laid up into the mold. The block may allow to adjust the height of the protrusion such that an end face of the trailing edge spar cap can be flush with a top face of the protrusion. Thereby, the block may facilitate to fix the trailing edge spar cap to the mold during the manufacturing process.

The layup surface can be configured for laying up the elements of the half shell, for example main laminates, spar caps, fiber material layers, core material, shear webs et cetera.

In an embodiment, the protrusion ranges in a longitudinal direction from a root end of the mold to a tip end of the mold, wherein the block has a length in the longitudinal direction which is a fraction of the length of the protrusion. For example, the length of the block in the longitudinal direction may be less than one percent of the length of the protrusion in the longitudinal direction. The block may be used to provide a surface which a clipping layer abuts. As the clipping layers have a relatively small extension in the lateral direction, the block can also have a small extension in the lateral direction. For example, the block may have a length in the range of 3 cm to 30 cm, preferably, in the range of 5 cm to 20 cm.

In an embodiment, the set includes multiple blocks which are configured to be arranged on the protrusion to elevate a height of parts of the protrusion, wherein at least two of the multiple blocks differ in their height. The height of the half shell resp. the spar cap may extend beyond the protrusion at least in one section along the longitudinal direction. Towards the tip end, the half shell becomes narrower and smaller. Thus, a height by which the half shell extends over the protrusion may become smaller towards the tip end. In order to match the height of the protrusion to the height of the half shell resp. spar cap over the entire length of the half shell, blocks of different heights are required.

A third aspect concerns an assembly including a spar cap and a mold. The spar cap may be the above-described spar cap of the first aspect. The mold may be part of the above-described set of the second aspect. The embodiments described above with respect to first and second aspect analogously apply to the third aspect.

In the assembly, the mold includes a layup surface and a protrusion which defines an edge of the mold. At least one block is arranged on the protrusion in a part of the protrusion in which a clipping layer is located. The spar cap is configured to be arranged in the mold such that an end face of the stack is flush with the protrusion and/or the block and the clipping layer protrudes beyond the protrusion and/or the block.

The protrusion can either be flush with the end face of the stack without a block, or a block can be used to elevate the protrusion such that it is flush with the top face of the stack.

The end face of the stack may be perpendicular to the top face and to the bottom face of the stack. The end face of the stack may face to the trailing edge of the half shell.

The assembly may allow to construct a half shell in which the trailing edge spar cap is placed with a high precision and in which deformations, in particular an undulation, of the trailing edge spar cap can be avoided.

In an embodiment, the assembly further includes a clamping device, which is configured to fix the part of the clipping element which protrudes beyond the protrusion and/or block to the mold. This contributes to the above-mentioned functions and advantages.

In an embodiment, the assembly is configured such that a position of the spar cap in the mold is maintained by the clamping device fixing the part of the clipping element which protrudes beyond the protrusion and/or block to the mold. This contributes to the above-mentioned functions and advantages.

In an embodiment, the spar cap includes multiple clipping layers, each clipping layer being arranged at a different position along a longitudinal direction of the spar cap and each clipping layer protruding beyond the protrusion and/or block, wherein the clamping device is configured to fix the part of each of the clipping element which protrudes beyond the protrusion to the mold. For each of the clipping layers, exactly one block may be provided on the protrusion. This contributes to the above-mentioned functions and advantages.

According to an embodiment, a height of the spar cap is greater than a height of the protrusion in at least a part of the mold, wherein the assembly includes multiple blocks, each block being configured to be arranged on the protrusion to elevate the protrusion in a location in which one of the clipping layers is arranged. A height of the blocks is chosen such, that a top surface of the blocks is flush with an end face of the spar cap. This contributes to the above-mentioned functions and advantages.

According to a fourth aspect, a method of manufacturing a half shell of a wind turbine rotor blade is proposed. The half shell may include the spar cap described above with respect to the first aspect and for the method, the set of the second aspect and the assembly of the third aspect may be used. The embodiments described above with respect to first to third aspect analogously apply to the fourth aspect.

The method includes the steps of:
i. manufacturing a spar cap including a stack of fiber material layers, which are stacked in a stacking direction from a bottom face to a top face, and a clipping layer, which is arranged on the top face of the stack such that the clipping layer protrudes beyond the stack of fiber material layers in a lateral direction which is perpendicular to the stacking direction,
ii. providing a mold, wherein the mold includes a layup surface and a protrusion which defines an edge of the mold,
iii. placing a block on the protrusion at a position at which the clipping layer will be located, wherein the block elevates the protrusion,
iv. arranging the spar cap in the mold, wherein the spar cap is arranged such that an end face of the stack is flush with the protrusion and/or the blocks and such that the clipping layer protrudes beyond the protrusion and/or the blocks,
v. fixing the part of the clipping element which protrudes beyond the protrusion at the mold.

Multiple clipping layers can be provided on the spar cap in step i. Multiple blocks may be placed on the protrusion in step iii., each block being placed at a position at which a clipping layer will be located. The blocks can differ in their height, wherein a height of the blocks is reduced towards the tip end of the spar cap.

### BRIEF DESCRIPTION OF DRAWINGS

The disclosure will now be described with reference to the drawings wherein:

FIG. 1 shows a schematic view of a wind turbine;

FIG. 2 shows a schematic view of a rotor blade;

FIG. 3 shows a schematic view of a cross-section of the wind turbine rotor blade;

FIG. 4 shows a schematic top view on a wind turbine rotor blade;

FIG. 5 shows a schematic view of a spar cap;

FIG. 6 shows a cross-sectional view of the spar cap shown in FIG. 5;

FIG. 7 shows the manufacturing process of a half shell;

FIG. 8 shows a set including a block being arranged on a protrusion of a mold;

FIG. 9 shows the set of FIG. 8 and a spar cap arranged in the mold;

FIG. 10 shows another block being arranged on the protrusion of the mold; and,

FIG. 11 shows a flow chart of a method of manufacturing a half shell of a wind turbine rotor blade.

### DETAILED DESCRIPTION

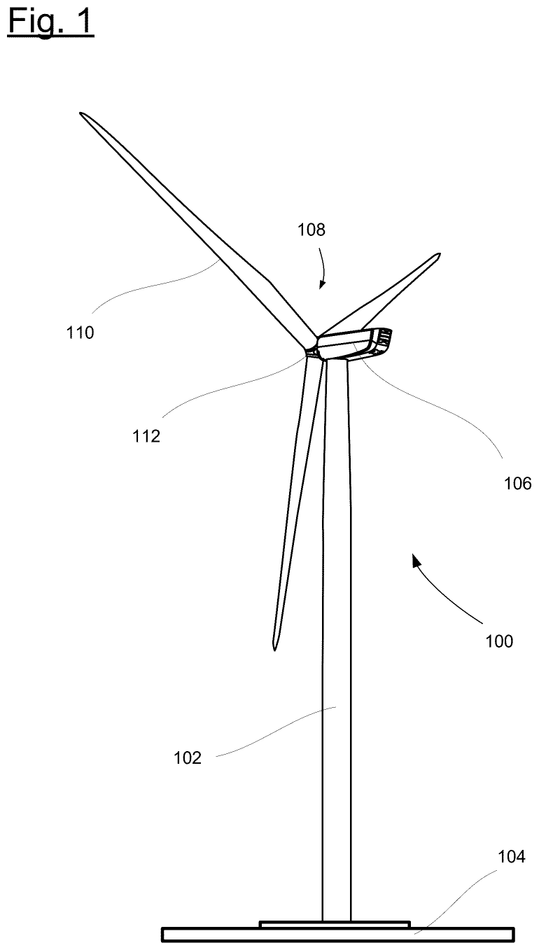

FIG. 1 shows a schematic view of a wind turbine 100, which includes a tower 102. The tower 102 is fixed to the ground via a foundation 104. A nacelle 106 is rotatably mounted at one end of the tower 102, opposite to the ground. The nacelle 106, for example, includes a generator which is coupled to a rotor 108 via a rotor shaft (not shown). The rotor 108 includes one or more (wind turbine) rotor blades 110, which are arranged on a rotor hub 112.

During operation, the rotor 108 is set in rotation by an air flow, for example wind. This rotational movement is transmitted to the generator via the rotor shaft and, if necessary, a gearbox. The generator converts the mechanical energy of the rotor 108 into electrical energy.

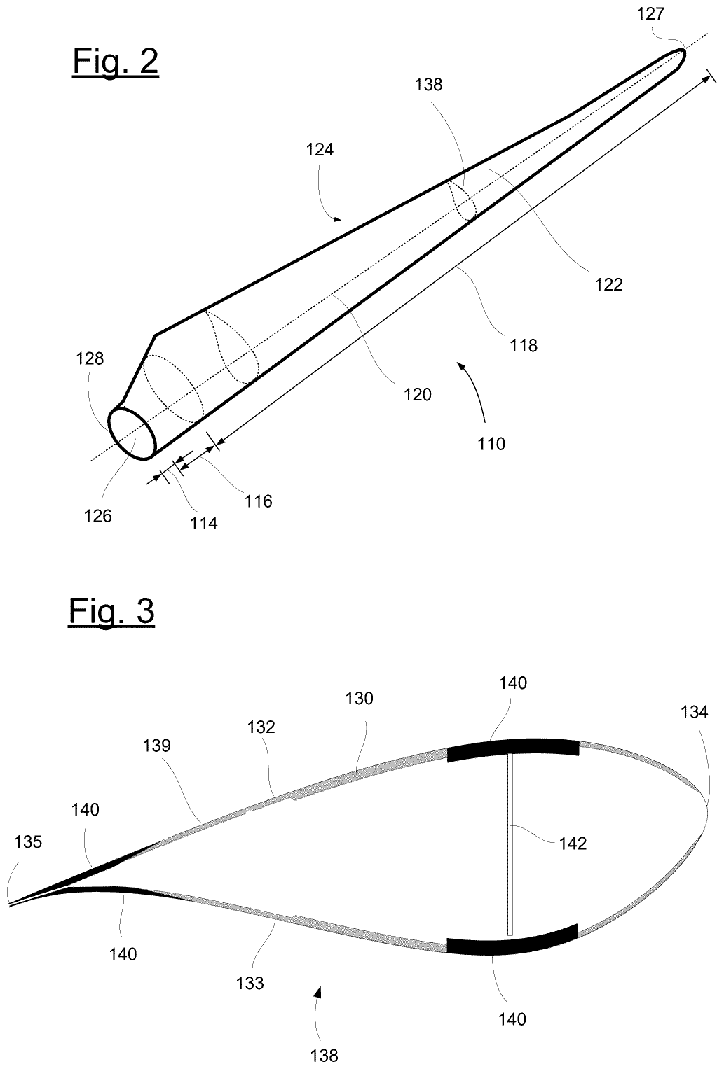

FIG. 2 shows a rotor blade 110. The rotor blade 110 has the shape of a conventional rotor blade and has a rotor blade root area 114 facing the rotor hub 112. The rotor blade root area 114 typically has an essentially circular cross-section. The rotor blade root area 114 is followed by a transition area 116 and a profile area 118 of the rotor blade 110. The rotor blade 110 has a pressure side 122 and an opposite suction side 124 extending along a longitudinal direction 120 (also main extension direction). The rotor blade 110 is essentially hollow inside.

In the rotor blade root area 114 a rotor blade root end 126 with a flange connection 128 is provided, via which the rotor blade 110 can be mechanically connected to a pitch bearing or an extender. The rotor blade 110 can be a segmented rotor blade.

FIG. 3 shows a schematic cross-section profile 138 (see FIG. 2) of the wind turbine rotor blade 110 running traverse to the longitudinal direction 120. The rotor blade 110 has an aerodynamic shell 130 including two half shells, that is, a pressure side half shell 133 and a suction side half shell 132. The two half shells 132, 133 are firmly connected to each other along the longitudinal axis at opposite connecting surfaces located at the leading edge 134 and trailing edge 135.

Each half shell 132, 133 includes a shell-structure which includes a shell laminate 139 and two spar caps 140, that is, a primary spar cap and a trailing edge spar cap. The shell laminate 139 includes a core material which is sandwiched between one or more layers of a laminate.

The spar caps 140 are embedded in the shell-structure. A spar cap 140 can also be generally named “main laminate” and carries main loads during operation of the rotor blade 110. Each of the spar caps 140 includes a stack 141 of fiber layers, which are placed on top of each other during manufacture according to a specific layup pattern. After the layup, the fiber layers are infused with resin and cured afterwards to form the rigid structural spar cap 14140. For the fiber layers, raw material is utilized, for example, fibrous material layers or semi-finished products like pultruded planks made from a fiber reinforced plastics material. Each of the spar caps 140 can be manufactured as a prefabricated part or as an integral part of a rotor blade shell 130 during the shell manufacture.

The rotor blade 110 includes a shear web 142. The shear web 142 connects the primary spar cap 140 of the pressure side half shell 132 to the primary spar cap 140 of the suction side half shell 133. The two primary spar caps 140 and the shear web 142 form a primary load-carrying structural member.

In an alternative embodiment, the rotor blade 110 additionally includes a second shear web which connects the trailing edge spar caps 140 to each other.

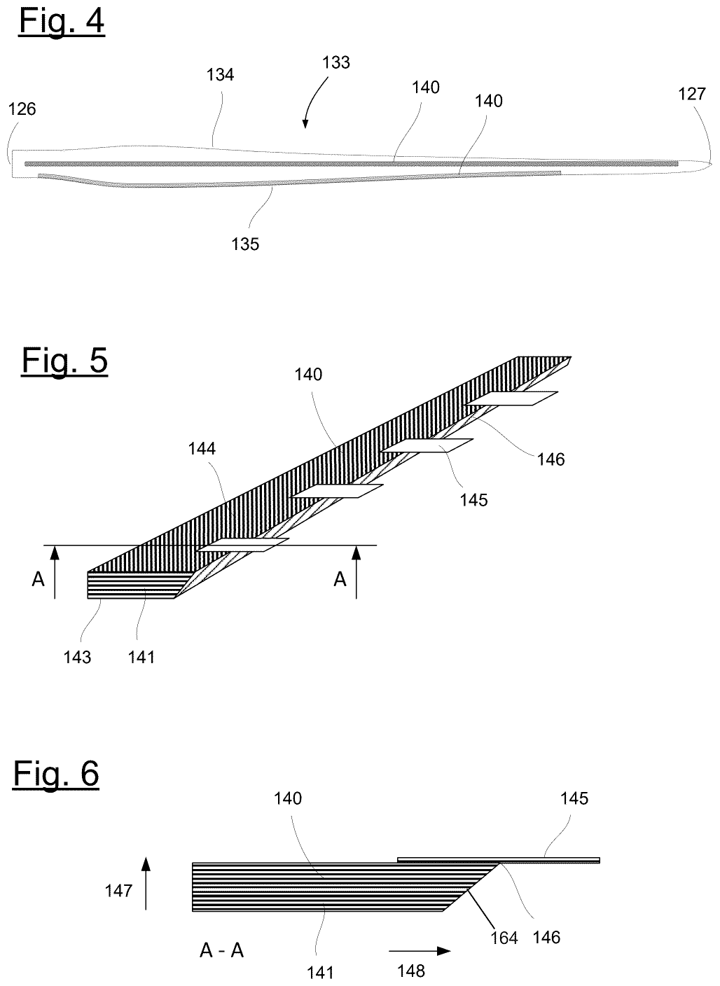

FIG. 4 shows a schematic top view of a wind turbine rotor blade 110, which has two spar caps 140 in each of the rotor blade half shells 132, 133. In FIG. 4, the pressure side half shell 133 including the primary spar cap 140 and the trailing edge spar cap 140 is visible.

All of the spar caps 140 extend along the longitudinal direction 120 of the wind turbine rotor blade 110, wherein the trailing edge spar cap 140 of the pressure side half shell 133 and the trailing edge spar cap 140 of the suction side half shell 132 extend closely along the trailing edge 135, at least in a section (or portion) between the root end 126 and a tip end 127.

In a part of the rotor blade 110, the trailing edge 135 is formed by the two trailing edge spar caps 140 and an adhesive joint between the trailing edge spar caps 140. In this part, the trailing edge spar caps 140 are arranged directly at the trailing edge 135. By arranging the trailing edge spar caps 140 directly at the trailing edge 135 a secondary load path along the trailing edge 135 of the wind turbine rotor blade 110 is formed, which stabilizes the trailing edge 135 particularly in edgewise load cases. Moreover, the trailing edge spar caps 140 create the majority of edgewise stiffness of the wind turbine rotor blade 110.

FIG. 5 shows a spar cap 140 according to the present disclosure in a perspective view. FIG. 6 shows a cross-sectional view of a spar cap 140 shown in FIG. 5 taken along the line AA. The spar cap 140 shown in FIGS. 5 and 6 is a trailing edge spar cap. FIGS. 5 and 6 show the spar cap 140 as a prefabricated part before it is integrated into the shell structure of a half shell.

The spar cap 140 includes a stack 141 of fiber material layers which are stacked in a stacking direction 147 from a bottom face 143 of the spar cap 140 to a top face 144 of the spar cap 140.

On the top face 144 of the spar cap 140, multiple clipping layers 145 are arranged. The clipping layers 145 may include one or more layers of a bidirectional fiber material or of another fiber material. Alternatively, the clipping layer may include glass fiber reinforced plastic.

The clipping layers 145 are arranged at a regular interval along the trailing edge 146 of the spar cap 140. Each clipping layer 145 protrudes beyond the trailing edge 146 of the spar cap 140 in a lateral direction 148. The lateral direction 148 corresponds to the chordwise direction when the spar cap 140 is integrated in a rotor blade 110. The lateral direction 148 is perpendicular to the stacking direction 147 of the stack 141 of fiber material layers and the lateral direction 148 is substantially perpendicular to a longitudinal direction 120, wherein the longitudinal direction 120 is the direction in which the spar cap 140 has the longest extension. For example, the lateral direction 148 and the longitudinal direction 120 may enclose an angle in the range of 75° to 105°, preferably, the two directions are perpendicular to each other.

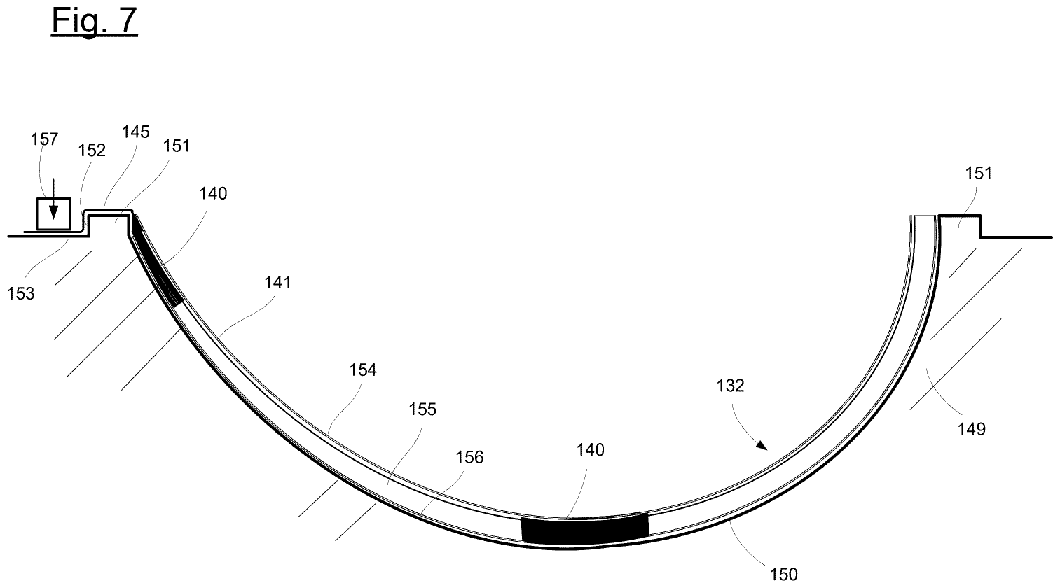

The stack 141 of fiber material layers and the clipping layer 145 are infused with resin and cured and thereby fixed to each other. The clipping layer 145 forms a fixing element which is used to fix the spar cap in a mold 149 when manufacturing the rotor blade 110 (see FIG. 7).

In the finalized rotor blade 110, the part of the clipping layer 145 which protrudes beyond the stack 141 of fiber material layers of the spar cap 140 is removed. The clipping layer 145 has a length in the lateral direction 148 which is in the range between 200 and 300 mm.

FIG. 5 shows that multiple clipping layers 145 are arranged along the trailing edge 146 of the spar cap 140. The clipping layers 145 which are arranged close to the root end of the spar cap 140 include more layers of a bidirectional fiber material than those clipping layers 145 arranged close to a tip end of the spar cap 140. At the root end, the stack 141 of fiber material layers includes more layers than in a region close to the tip end. Thus, in the region close to the root end, stronger clipping layers 145 are required for fixing the spar cap 140 in the mold 149, that is, clipping layers 145 with more layers.

An end face 164 of the stack is arranged at the trailing edge 145. The end face 164 is tapered with respect to the stacking direction of the stack. As shown in FIGS. 7 and 9, this allows the end face 164 to abut the mold 149 or a tapered inwardly facing surface 161 of a block 158.

FIG. 7 shows a half shell 132 of a wind turbine rotor blade 110 during its manufacturing. For manufacturing the half shell 132 of the wind turbine rotor blade 110, a mold 149 is used which includes a layup surface 150 and two protrusions 151 defining edges of the mold 149. One of the protrusions 151 defines an edge which corresponds to the trailing edge 135 of the half shell 132 and the other protrusion 151 defines an edge which corresponds to the leading edge 134 of the half shell 132.

In an outward direction away from the layup surface 150, the mold 149 includes a step 152 and a clamping surface 153 which are adjacent to the protrusion 151. In an alternative embodiment, the step 152 may be omitted and the protrusion 151 may be used as a clamping surface.

Each element of the half shell 132 is subsequently arranged on the layup surface 150 of the mold 149. In particular, an outer laminate layer 156, a core material 155 and an inner laminate layer 154 are subsequently arranged on the layup surface 150 of the mold 149, thereby forming a shell structure of the half shell 132. Additionally, prefabricated parts, that is, the primary spar cap 140 and the trailing edge spar cap 140, are arranged on the layup surface of the mold, wherein the spar caps 140 are adjacent to the core material 155.

The trailing edge spar cap 140 is arranged in the mold 149 such that the trailing edge of the stack 141 of fiber material layers matches the contour of the stack 141 of fiber material layers protrusion 151. The clipping layer 145 protruding beyond is arranged on the protrusion 151 and extends beyond the protrusion 151. The clipping layer 145 is also arranged on the clamping surface 153 of the mold 149.

As indicated in FIG. 7, a clamping device 157 fixes the part of the clipping layer 145 which protrudes beyond the protrusion 151 to the mold 149. For example, the clipping layer 145 is clamped between the clamping device 157 and the clamping surface 153 of the mold 149. This allows the trailing edge spar cap 140 to be fixed at its position before the trailing edge spar cap 140 is fixed to the shell structure of the half shell 132, for example by resin infusion.

By providing the clipping layer 145 which is fixed to the mold 149 via clamping, it can be ensured that accidental movements of the trailing edge spar cap 140 relative to the mold 149 are prevented. Thus, the clipping layer 145 enables to position the trailing edge spar cap 140 in the half shell 132 with a high precision.

The half shell 132 is manufactured by (vacuum) resin infusion wherein the elements arranged on the mold 149 are fixed to each other. Afterwards, the protruding part of the clipping layer 145 is removed in a trimming operation. In the trimming operation, a grinder, for example an electrical or pneumatic grinder, is used to remove the protruding part of the clipping layer 145.

In the embodiment shown in FIG. 7, the protrusion 151 of the mold 149 is flush with an end face 164 of the stack 141 of fiber material layers. The bottom face 143 of the stack 141 lays against the layup surface 150 of the mold 149.

In an alternative embodiment, at another length position of the half shell (not shown), the protrusion 151 is not flush with the end face 164 of the stack 141 and instead the end face of the stack 141 may be higher than the protrusion 151 and may, therefore, protrude beyond the protrusion 151. In order to elevate the height of the protrusion 151 such that the protrusion 151 becomes flush with the end face 164 of the stack 141, a block 158 is arranged on the protrusion 151. In particular, the block 158 is arranged on a part of the protrusion 151 in which the clipping layer 145 is located.

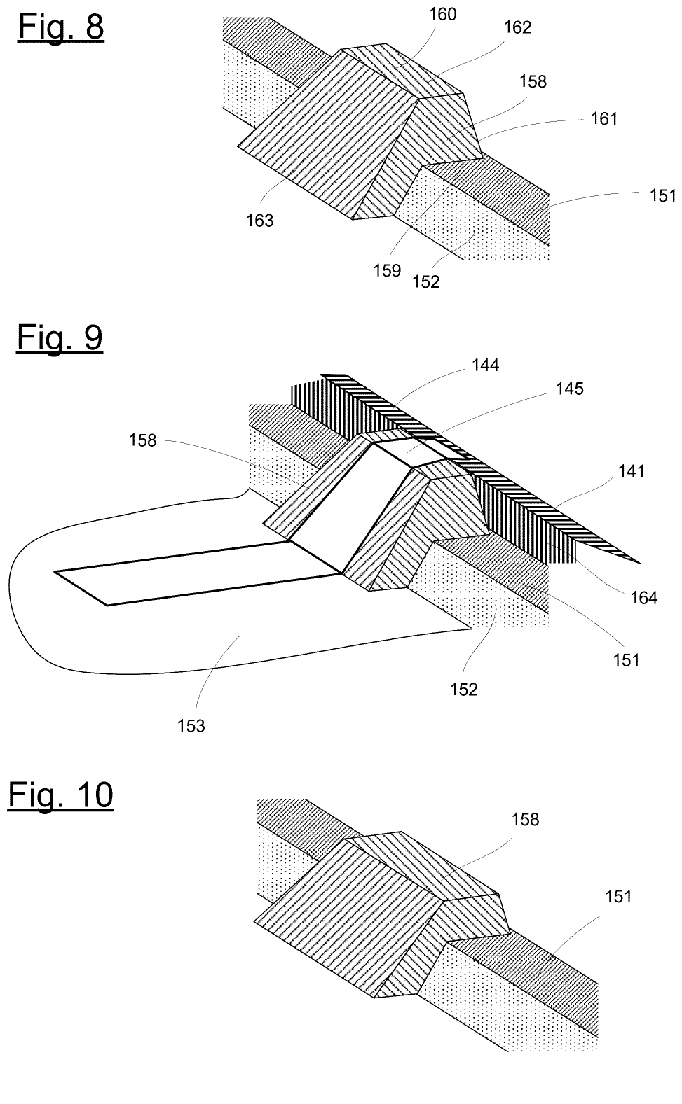

FIG. 8 shows the block 158 arranged on a part of the protrusion 151. In FIG. 8, the spar cap 140 including the clipping layer 145 is not shown. The spar cap 140 will be arranged on the layup surface 150 of the mold 149 wherein the position of the block 158 is chosen such that clipping layer 145 is arranged on the block 158.

The shape of the block 158 is adapted to the shape of the mold 149. The block 158 includes a bottom surface 159 which faces towards the mold 149. The shape of the bottom surface 159 of the block 158 matches the shapes of the protrusion 151, the step 152 and the clamping surface 153 of the mold 149.

The block 158 includes a top surface 160 which is opposite of the bottom surface 159. The top surface 160 of the block 158 includes three surfaces, a tapered inwardly facing surface 161, a surface 162 parallel to the protrusion 151 and a tapered outwardly facing surface 162. A height of the block 158 is measured from the upper surface of the protrusion 151 to the part of top surface 160 of the block 158 which is parallel to the protrusion 151.

FIG. 9 shows the mold 149 shown in FIG. 8 after the spar cap 140 is arranged in the mold 149. When the spar cap 140 is arranged in the mold 149, the end face 164 of the stack 141 of fiber layers abuts the tapered inwardly facing surface 161 of the block 158. The top face 144 is flush with the surface 162 of the block 158. The bottom face 143 of the spar cap 140 is laying on the layup surface 150 of the mold 149 (not visible). The clipping layer 145 located on the top face 144 of the stack 141, is arranged on the surface 162 of the block 158 running parallel to the protrusion 151 and on the tapered outwardly facing surface 163. The clipping layer 145 extends beyond the block and is additionally arranged on the clamping surface 153. The clipping layer 145 is cured and corresponds to the shape of the protrusion 151.

The clipping layer 145 may be temporarily fixed to the mold by a clamping device 157 pressing the clipping layer 145 onto the clamping surface 153 as shown in FIG. 7. Alternatively, the clamping device 157 may fix a part of the clipping layer 145 which rests on the surface 162 of the block 158 running parallel to the protrusion 151.

FIG. 10 shows another block 158 on the protrusion 151 of the mold 149. The block 158 shown in FIG. 10 is arranged further towards the tip end of the mold 149 than the block 158 shown in FIG. 8. The block 158 shown in FIG. 10 includes a lower height compared to the block 158 shown in FIG. 8. Along the longitudinal direction 120 from the root end of the half shell 132 towards the tip end of the half shell 132, a height of the spar cap 140 descends. To match the height of the protrusion 151 to the height of the spar cap 140, the blocks 158 arranged on the protrusion 151 differ in their height. The blocks 158 close to the root end have the highest height and the height of the blocks 158 is reduced more and more towards the tip end of the protrusion 151. It is also conceivable that no blocks 158 are arranged in a region close to the tip end as the spar cap 140 is flush with the protrusion 151 without blocks 158 close to the tip end.

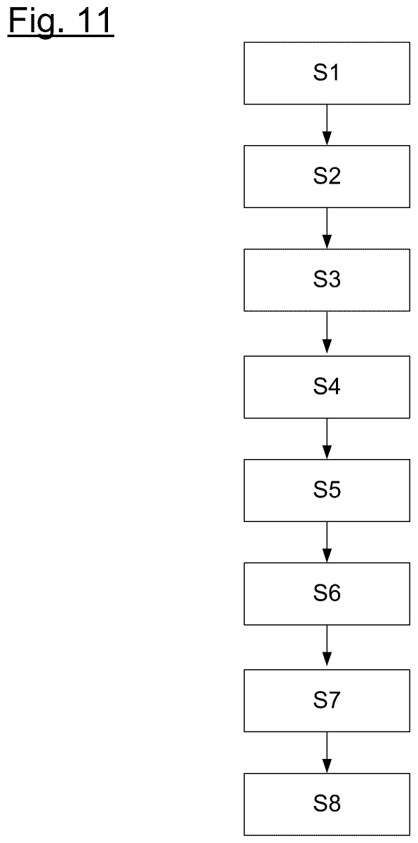

FIG. 11 shows a flow chart of a method for manufacturing a wind turbine rotor blade 110.

In a first step S1, a spar cap 140 including a stack 141 of fiber material layers which are arranged in a stacking direction 147 from a bottom face 143 to a top face 144 is manufactured. The spar cap 140 further includes a clipping layer 145 arranged on the top face 144 of the stack 141 such that the clipping layer 145 protrudes beyond the stack 141 of fiber material layers in a lateral direction 148 which is perpendicular to the to the stacking direction 147. For example, the spar cap 140 as manufactured in step S1 may be the same spar cap as the spar cap shown in FIGS. 5 and 6.

In a subsequent second step S2, a mold 149 is provided. The mold 149 includes a layup surface 150 and a protrusion 151 defining an edge of the mold 149. The mold 149 provided in step S2 may correspond to the mold shown in FIG. 7.

In a third step S3, a block 158 is placed on the protrusion 151 of the mold 149 at the position at which the clipping layer 141 will be located. The block 158 elevates the protrusion 151. In step S3, multiple blocks 158 may be arranged at different positions along the longitudinal direction 120 of the protrusion 151. The blocks 158 arranged on the protrusion 151 in step S3 are shown, for example in FIGS. 8 and 10.

In a subsequent fourth step S4, the spar cap 140 is arranged in the mold 149. The spar cap 140 is arranged such that the top face 144 of the stack 141 is flush with the protrusion 151, which may be elevated by a block 158, and such that the clipping layer 145 protrudes beyond the protrusion 151, which may be elevated by a block 158. The spar cap 140 being arranged in the mold 149 is shown, for example, in FIGS. 7 and 9.

FIG. 7 shows an embodiment wherein no block 158 is provided on the protrusion 151 of the mold 149 and wherein the stack 141 is flush with the protrusion 151. FIG. 9 shows an embodiment wherein a block 158 is arranged on the protrusion 151 at the position at which the clipping layer 145 will be arranged and wherein the end face 164 of the stack 141 abuts the block 158.

In a subsequent fifth step S5, the part of the clipping layer 145 which protrudes beyond the protrusion 151 of the mold 149 is fixed at the mold 149. For example, FIG. 7 shows the fixation of the clipping layer 145 to a clamping surface 153 of the mold 149 by a clamping device 157.

In a sixth step S6, further laminate layers and a core material are arranged on the layup surface, thereby providing a shell structure.

In a seventh step S7, the spar cap is fixed to the shell structure, for example, by resin infusion and curing, thereby forming a half shell.

Steps S1 to S7 are repeated to manufacture a second half shell.

In an eighth step S8, the two half shells are fixed to each other, for example, via adhesive connections at the trailing edge and at the leading edge.

It is understood that the foregoing description is that of the preferred embodiments of the invention and that various changes and modifications may be made thereto without departing from the spirit and scope of the invention as defined in the appended claims.

### REFERENCE NUMBERS

100 wind turbine
102 tower
104 foundation
106 nacelle
108 rotor
110 rotor blade
112 rotor hub
114 rotor blade root area
116 transition area
118 profile area
120 longitudinal direction
122 pressure side
124 suction side
126 root end
127 tip end
128 flange connection
130 shell
132 suction side half shell
133 pressure side half shell
134 leading edge
135 trailing edge of the rotor blade
138 cross-sectional profile
139 shell laminate
140 spar cap
141 stack of fiber layers
142 shear web
143 bottom face
144 top face
145 clipping layer
146 trailing edge of the spar cap
147 stacking direction
148 lateral direction/chordwise direction
149 mold
150 layup surface
151 protrusion
152 step
153 clamping surface
154 inner laminate layer
155 core material
156 outer laminate layer
157 clamping device
158 block
159 bottom surface
160 top surface
161 inwardly facing surface
162 parallel surface
163 outwardly facing surface
164 end face

1. A spar cap for a wind turbine rotor blade, the spar cap comprising:
a stack of fiber material layers, which are stacked in a stacking direction from a bottom face to a top face;
a clipping layer arranged on said top face of said stack of fiber material layers; and,
said clipping layer protruding beyond said stack of fiber material layers in a lateral direction perpendicular to said stacking direction.

2. The spar cap of claim 1, wherein said stack of fiber material layers and said clipping layer are infused with resin.

3. The spar cap of claim 1, wherein said clipping layer forms a fixing element configured to fix the spar cap in a mold.

4. The spar cap of claim 3, wherein a chordwise cross-sectional shape of said clipping layer is complementary to a chordwise cross-sectional shape of a protrusion forming an edge of the mold.

5. The spar cap of claim 1, wherein the spar cap is a trailing edge spar cap.

6. A set for manufacturing a half shell of a wind turbine rotor blade, comprising:
a mold having a layup surface and a protrusion which defines an edge of said mold; and,
at least one block arranged on said protrusion to elevate a height of a part of said protrusion.

7. The set of claim 6, wherein said protrusion ranges in a longitudinal direction from a root end of said mold to a tip end of said mold; and, said at least one block has a length in the longitudinal direction which is a fraction of said length of said protrusion.

8. The set of claim 6 further comprising a multiplicity of blocks arranged on said protrusion to elevate a height of parts of said protrusion; and, wherein at least two of said multiplicity of blocks differ in height.

9. An assembly comprising:
a spar cap including a stack of fiber material layers, which are stacked in a stacking direction from a bottom face to a top face;
said spar cap further including a clipping layer arranged on said top face of said stack of fiber material layers;
said clipping layer protruding beyond said stack of fiber material layers in a lateral direction perpendicular to said stacking direction;
a mold having a layup surface and a protrusion which defines an edge of said mold;
at least one block arranged on said protrusion in a part of said protrusion in which the clipping layer is located; and,
said spar cap being configured to be arranged in said mold such that said top face of said stack of fiber materials is flush with at least one of said protrusion and said at least one block and said clipping layer protrudes beyond at least one of said protrusion and said at least one block.

10. The assembly of claim 9 further comprising a clamping device configured to fix a part of said clipping layer which protrudes beyond at least one of said protrusion and said at least one block to said mold.

11. The assembly of claim 10, wherein the assembly is configured such that a position of said spar cap in said mold is maintained by said clamping device fixing said part of said clipping layer which protrudes beyond at least one of said protrusion and said at least one block to said mold.

12. The assembly of claim 10, wherein said spar cap includes a multiplicity of clipping layers; each of said multiplicity of clipping layers is arranged at a different position along a longitudinal direction of said spar cap and each of said multiplicity of clipping layers protrudes beyond at least one of said protrusion and said at least one block; and,
said clamping device is configured to fix said part of each of said multiplicity of clipping layers which protrudes beyond said at least one of said protrusion and said at least one block to said mold.

13. The assembly of claim 12, wherein:
a height of said spar cap is greater than a height of said protrusion in at least a part of said mold;
said assembly includes a multiplicity of said at least one block, each of said multiplicity of blocks being configured to be arranged on said protrusion to elevate said protrusion in a location in which one of said multiplicity of clipping layers is arranged; and,
wherein a height of said multiplicity of blocks is chosen such that a top surface of said multiplicity of blocks is flush with an end face of said spar cap.

14. The assembly of claim 13, wherein said end face defines a trailing edge of said spar cap at least in a section between a root end and a tip end of a half shell.

15. A method of manufacturing a half shell of a wind turbine rotor blade, the method comprising:
manufacturing a spar cap having a stack of fiber material layers stacked in a stacking direction from a bottom face to a top face and a clipping layer arranged on the top face of the stack such that the clipping layer protrudes beyond the stack of fiber material layers in a lateral direction which is perpendicular to the stacking direction;
providing a mold, wherein the mold has a layup surface and a protrusion which defines an edge of the mold;
placing a block on the protrusion at a position at which the clipping layer will be located, wherein the block elevates the protrusion;
arranging the spar cap in the mold, wherein the spar cap is arranged such that the top face of the stack is flush with at least one of the protrusion and the block and such that the clipping layer protrudes beyond at least one of the protrusion and the block; and,
fixing the part of the clipping layer which protrudes beyond the protrusion at the mold.
